(19) United States
(12) Patent Application Publication
(10) Pub. No.: US 2005/0266999 A1
(43) Pub. Date: Dec. 1, 2005

(54) Concentrated aqueous formulations for crop protection

(75) Inventors: Gerhard Frisch, Wehrheim (DE); Gerhard Schnabel, Elsenfeld (DE); Janine Rude, Kriftel (DE)

Correspondence Address: FROMMER LAWRENCE & HAUG, 745 FIFTH AVENUE- 10TH FL., NEW YORK, NY, 10151, US

(73) Assignee: Bayer CropScience GmbH

(21) Appl. No.: 11/140,363

(22) Filed: May 27, 2005

(30) Foreign Application Priority Data
Jun. 1, 2004 (DE) 10 2004 026 937.8

(51) Int. Cl. A01N 25/16

(52) U.S. Cl. 504/365

(57) ABSTRACT

Liquid aqueous formulations of water-soluble active crop protectant ingredients, comprising (a) one or more water-soluble active crop protectant ingredients (type (a) ingredients), (b) if desired, one or more water-insoluble active crop protectant ingredients (type (b) ingredients), (c) if desired, organic solvents, (d) nonionic, cationic, anionic and/or zwitterionic surfactants, (e) nonionic surfactants from the group of the alkylpolyglycosides, (f) inorganic salts from the group of ammonium salts, (g) if desired, other nonionic, anionic, cationic and/or zwitterionic surfactants, (h) if desired, other customary formulation assistants, and (i) water, are suitable as concentrated formulations for use in crop protection.

The invention relates to the technical field of preparations (formulations) for active ingredients in the crop protection field (agrochemical active ingredients), preferably aqueous formulations of water-soluble active crop protectant ingredients, especially aqueous formulations of saltlike active crop protectant ingredients, and very particularly glufosinate-ammonium.

Aqueous formulations of glufosinate-ammonium are known, for example, from EP-A-0048436, EP-A-00336151, and EP-A-1093722. Formulations include surfactants, which increase the activity of the herbicide. In general, however, the activity is dependent on the proportion of active ingredient and surfactant and the concentrations. For example, certain of the formulations of glufosinate-ammonium include a fraction of fatty alcohol polyglycol ether sulfate (e.g., lauryl ether sulfate, ®Genapol LRO, Clariant), which in the formulations increases the activity of the glufosinate-ammonium. Frequently, however, in the formulations of glufosinate-ammonium with an active ingredient content of 120 g/l, 150 g/l or 200 g/l, for example, activity losses are observed if the fraction of surfactants such as fatty alcohol polyglycol ether sulfate is increased beyond a certain amount.

On the other hand, generally speaking, there is a need for high-concentration formulations of crop protectants, since the higher concentration has a multitude of advantages; with high-concentration formulations, for example, the necessary packaging involved is less than with low-concentration formulations. There are corresponding reductions in the cost and inconvenience of production, transit, and storage; moreover, preparation of spray liquors is simplified by the smaller quantities of crop protectant that need to be handled—dispensed and stirred up, for example.

Surprisingly it has now been found that by adding small amounts of certain formulation assistants it is possible to prepare formulations of water-soluble crop protectants that are of comparatively high concentration, i.e., include a higher level of active ingredients and/or activity-boosting surfactants, and allow a comparable or improved biological activity in the application.

The invention accordingly provides liquid aqueous crop protectant compositions of water-soluble active crop protectant ingredients, comprising
(a) one or more water-soluble active crop protectant ingredients (type (a) active ingredients),
(b) if desired, one or more water-insoluble active crop protectant ingredients (type (b) active ingredients),
(c) if desired, organic solvents,
(d) nonionic, cationic, anionic and/or zwitterionic surfactants,
(e) nonionic surfactants from the group of the alkylpolyglycosides,
(f) inorganic salts from the group of ammonium salts,
(g) if desired, other nonionic, anionic, cationic and/or zwitterionic surfactants,
(h) if desired, other customary formulation assistants, and
(i) water.

The aqueous formulations of the invention are suitable with preference for active ingredients of type (a) from the group of the salt-containing water-soluble crop protectant ingredients such as glufosinate (salts), glyphosate (salts), paraquat, diquat, and the like, especially glufosinate-ammonium.

The formulations of the invention may further comprise active ingredients of type (b), which are substantially insoluble in water, examples being herbicides from the group of diphenyl ethers, carbamates, thiocarbamates, triphenyltin and tributyltin compounds, haloacetanilides, phenoxyphenoxyalkanecarboxylic acid derivatives and heteroaryloxyphenoxyalkanecarboxylic acid derivatives, such as quinolyloxy-, quinoxalyloxy-, pyridyloxy-, benzoxalyloxy- and benzothiazolyloxyphenoxyalkanecarboxylic esters, which generally have a suitable solubility in organic solvents, examples being active ingredients such as oxyfluorfen, diclofop-methyl, fenoxaprop-ethyl or fenoxaprop-P-ethyl.

Also suitable are correspondingly insoluble active ingredients from classes of substance which normally include active ingredients of different solubilities, examples being active ingredients from the group of cyclohexanedione derivatives, imidazolinones, pyrimidyloxypyridinecarboxylic acid derivatives, pyrimidyloxybenzoic acid derivatives, sulfonylureas, triazolopyrimidinesulfonamide derivatives, and S—(N-aryl-N-alkylcarbamoylmethyl)dithiophosphoric esters.

Correspondingly it is also possible to consider active ingredients from the group of safeners, plant growth regulators, insecticides, and fungicides as component (b) and/or, in the case of good water solubility, as components (a).

The type of active ingredients (a) and (b) used determine the type of pests which can be controlled by application of the crop protection compositions or agrochemical formulations. In case of herbicides the pests are undesired plants.

Preference is given to formulations comprising type (a) active ingredients from the group consisting of one or more compounds of the formula (1) or salts thereof, 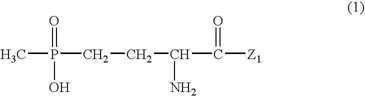
in which
Z₁ is a radical of the formula —OM, —NHCH(CH₃)CONHCH(CH₃)CO₂M or —NHCH(CH₃)CONHCH[CH₂CH(CH₃)₂]CO₂M, where
M=H or a salt-forming cation,
and/or one or more compounds of the formula (2) or salts thereof, 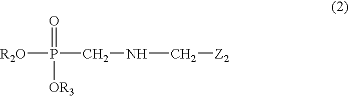
   in which
Z₂ is a radical of the formula CN or CO₂R₁, in which R₁=Q or a salt-forming cation and Q=H, alkyl, alkenyl, alkoxyalkyl or C₆-C₁₀ aryl which is unsubstituted or substituted and is preferably unsubstituted or substituted by one or more radicals from the group consisting of alkyl, alkoxy, halogen, CF₃, NO₂ and CN, and
R₂ and R₃ each independently of one another are H, alkyl or C₆-C₁₀ aryl which is unsubstituted or substituted and is preferably unsubstituted or substituted by one or more radicals from the group consisting of alkyl, alkoxy, halogen, CF₃, NO₂ and CN, or biphenylyl or a salt-forming cation.

Preferably, the carbon-containing radicals in connection with Q, R₂ or R₃, respectively have up to 10 carbon atoms, particularly preferred up to 6 carbon atoms.

The compounds of the formula (1) contain an asymmetric carbon atom. The L enantiomer is regarded as being the biologically active isomer. The formula (1) therefore embraces all stereoisomers and mixtures thereof, particularly the racemate, and the biologically active enantiomer in each case. Examples of active ingredients of the formula (1) are as follows:
glufosinate and its ammonium salt in racemic form, i.e., 2-amino4-[hydroxy(methyl)phosphinoyl]butanoic acid and its ammonium salt,
the L enantiomer of glufosinate and its ammonium salt,
bilanafos/bialaphos, i.e., L-2-amino4-[hydroxy(methyl)phosphinoyl]butanoyl-L-alaninyl-L-alanine and its sodium salt.

The racemate of glufosinate-ammonium on its own is usually applied at rates of between 200 and 1000 g a.i./ha (i.e., grams of active ingredient per hectare). Glufosinate-ammonium at these rates is effective in particular when it is taken up via green parts of the plant; see “The Pesticide Manual” 13th Edition, British Crop Protection Council 2003. Glufosinate-ammonium is used predominantly for controlling broadleaf and gramineous weeds in plantation crops and on uncultivated lands and also, using special application techniques, for inter-row control in agricultural or surface crops such as maize, cotton, etc. It is also of increasing significance for use in transgenic crops which are tolerant or resistant to the active ingredient.

The compounds of the formula (2) comprise N-(phosphonoalkyl)glycine and hence derivatives of the amino acid glycine. The herbicidal derivatives of N-(phosphonomethyl)glycine (glyphosate) have been described, for example, in U.S. Pat. No. 3,799,758.

Generally speaking, glyphosate is used in crop protectant formulations in the form of the water-soluble salts, with the isopropylammonium salt being of particular significance in connection with the present invention; see “The Pesticide Manual” 13th Edition, British Crop Protection Council 2003.

The stated active-ingredient common names such as glufosinate, glyphosate, oxyfluorfen, diclofop-methyl and fenoxaprop-(P-)ethyl are known to the skilled worker; see, for example, “The Pesticide Manual” 13th Edition, Crop Protection Council 2003. The names also include the known derivatives such as salts of glufosinate and glyphosate, particularly the commercially customary forms.

In connection with the present invention the term “organic solvents” (component (c)) identifies, for example, nonpolar solvents, polar protic solvents or aprotic polar solvents and mixtures thereof. Examples of solvents in the sense of the invention are
aliphatic or aromatic hydrocarbons, such as mineral oils and toluene, xylenes and naphthalene derivatives, for example,
halogenated aliphatic or aromatic hydrocarbons such as methylene chloride and chlorobenzene;
aliphatic alcohols, such as alkanols having 1 to 12 carbon atoms, preferably 1 to 6 carbon atoms, such as methanol, ethanol, propanol, isopropanol and butanol, for example, or polyhydric alcohols such as ethylene glycol and glycerol;
ethers such as diethyl ether, tetrahydrofuran (THF), and dioxane;
alkylene glycol monoalkyl and dialkyl ethers, such as propylene glycol monomethyl ether, propylene glycol monoethyl ether, ethylene glycol monomethyl and monoethyl ether, diglyme, and tetraglyme, for example;
amides such as dimethylformamide (DMF), dimethylacetamide, dimethylcaprylamide, dimethylcapramide (®Hallcomide), and N-alkylpyrrolidones;
ketones such as acetone;
esters based on glyceryl and carboxylic acids, such as glyceryl mono-, di- and triacetate,
phthalic esters;
lactams;
carbonic diesters;
nitriles such as acetonitrile, propionitrile, butyronitrile, and benzonitrile;
sulfoxides and sulfones such as dimethyl sulfoxide (DMSO) and sulfolane;
oils, examples being plant-based oils such as corn germ oil and rapeseed oil.

In many cases combinations of different solvents, additionally containing alcohols such as methanol, ethanol, n- and isopropanol, and n-, iso-, tert- and 2-butanol, are also suitable.

In the case of single-phase aqueous-organic solutions suitability is possessed by the wholly or largely water-miscible solvents or solvent mixtures.

Preferred organic solvents in the sense of the present invention are aromatic solvents such as toluene, o-, m- or p-xylene and mixtures thereof, 1-methylnaphthalene, 2-methylnaphthalene, 6-16 C aromatics mixtures such as, for example, the Solvesso® series (ESSO) with the grades Solvesso® 100 (b.p. 162-177° C.), Solvesso® 150 (b.p. 187-207° C.), and Solvesso® 200 (b.p. 219-282° C.), phthalic acid (1-12 C)alkyl esters, especially phthalic acid (4-8 C)alkyl esters, water-immiscible ketones, such as cyclohexanone or isophorone, for example, or 6-20 C aliphatics, which may be linear or cyclic, such as the products of the Shellsol® series, grades T and K, or BP-n paraffins, esters such as glyceryl triacetate, and the polar organic solvents N-methylpyrrolidone and Dowanol® PM (propylene glycol monomethyl ether).

Particular preference is given to the polar organic solvents.

The formulations of the invention comprise as component (d) anionic, cationic or zwitterionic and/or nonionic surface-active compounds (surfactants), which are intended to contribute to improved stability, availability for the plants, or activity of the formulated crop protectants.

Examples of anionic surfactants are as follows (where EO=ethylene oxide units, PO=propylene oxide units and BO=butylene oxide units):
d1-1) anionic derivatives of fatty alcohols having 10-24 carbon atoms with 0-60 EO and/or 0-20 PO and/or 0-15 BO in any order, in the form of ether carboxylates, sulfonates, sulfates, and phosphates, and their inorganic salts (e.g., alkali metal and alkaline earth metal salts) and organic salts (e.g., salts based on amine or alkanolamine), such as Genapol®LRO, Sandopan® grades, and Hostaphat/Hordaphos® grades from Clariant;
d1-2) anionic derivatives of copolymers consisting of EO, PO and/or BO units having a molecular weight of 400 to 10⁸, in the form of ether carboxylates, sulfonates, sulfates, and phosphates, and their inorganic salts (e.g., alkali metal and alkaline earth metal salts) and organic salts (e.g., salts based on amine or alkanolamine),
d1-3) anionic derivatives of alkylene oxide adducts of C₁-C₉ alcohols, in the form of ether carboxylates, sulfonates, sulfates and phosphates, and their inorganic salts (e.g., alkali metal and alkaline earth metal salts) and organic salts (e.g., salts based on amine or alkanolamine);
d1-4) anionic derivatives of fatty acid alkoxylates, in the form of ether carboxylates, sulfonates, sulfates and phosphates, and their inorganic salts (e.g., alkali metal and alkaline earth metal salts) and organic salts (e.g., salts based on amine or alkanolamine).

Preferred anionic surfactants are
alkyl polyglycol ether sulfates, especially fatty alcohol diethylene glycol ether sulfate (e.g., Genapol LRO®, Clariant), or
alkyl polyglycol ether carboxylates (e.g., 2-(isotridecyloxypolyethyleneoxy)ethyl carboxymethyl ether, Marlowet 4538®, Hüls).
Examples of cationic or zwitterionic surfactants are as follows (where EO=ethylene oxide units, PO=propylene oxide units, and BO=butylene oxide units):
d2-1) alkylene oxide adducts of fatty amines, quaternary ammonium compounds having 8 to 22 carbon atoms (C₈-C₂₂), such as the Genamin® C, L, O, and T grades from Clariant, for example;
d2-2) surface-active zwitterionic compounds such as taurides, betaines and sulfobetaines in the form of Tegotain® grades from Goldschmidt, and Hostapon®T and Arkopon®T grades from Clariant.

Examples of nonionic surfactants are:
d3-1) fatty alcohols having 10-24 carbon atoms with 0-60 EO and/or 0-20 PO and/or 0-15 BO in any order. Examples of such compounds are Genapol® C, L, O, T, UD, UDD, and X grades from Clariant, Plurafac® and Lutensol® A, AT, ON, and TO grades from BASF, Marlipal®24 and O13 grades from Condea, Dehypon® grades from Henkel, and Ethylan® grades from Akzo-Nobel, such as Ethylan CD 120;
d3-2) fatty acid alkoxylates and triglyceride alkoxylates such as the Serdox®NOG grades from Condea or the Emulsogen® grades from Clariant;
d3-3) fatty acid amide alkoxylates such as the Comperlan® grades from Henkel or the Amam® grades from Rhodia;
d3-4) alkylene oxide adducts of alkynediols, such as the Surfynol® grades from Air Products; sugar derivatives such as amino sugars and amido sugars from Clariant,
d3-5) glucitols from Clariant,
d3-6) silicone- and/or silane-based surface-active compounds such as the Tegopren® grades from Goldschmidt and the SE® grades from Wacker, and also the Bevaloid®, Rhodorsil®, and Silcolapse® grades from Rhodia (Dow Corning, Reliance, GE, Bayer),
d3-7) surface-active sulfonamides, from Bayer, for example;
d3-8) surface-active polyacrylic and polymethacrylic derivatives such as the Sokalan® grades from BASF;
d3-9) surface-active polyamides such as modified gelatins or derivatized polyaspartic acid from Bayer, and derivatives thereof,
d3-10) surfactant polyvinyl compounds such as modified PVP, such as the Luviskol® grades from BASF and the Agrimer® grades from ISP, or the derivatized polyvinyl acetates, such as the Mowilith® grades from Clariant, or the polyvinyl butyrates, such as the Lutonal® grades from BASF, the Vinnapas® and the Pioloform® grades from Wacker, or modified polyvinyl alcohols, such as the Mowiol® grades from Clariant,
d3-11) surface-active polymers based on maleic anhydride and/or reaction products of maleic anhydride and also maleic anhydride copolymers and/or copolymers containing reaction products of maleic anhydride, such as the Agrimer® VEMA grades from ISP,
d3-12) surface-active derivatives of montan waxes, polyethylene waxes, and polypropylene waxes, such as the Hoechst® waxes or the Licowet® grades from Clariant,
d3-13) polyol-based alkylene oxide adducts, such as Polyglycol® grades from Clariant;
d3-14) surface-active polyglycerides and derivatives thereof from Clariant.

The formulations of the invention comprise, as component (e), nonionic surfactants from the group of the alkylpolyglycosides. Of preferred suitability in this context are the following:
e1) alkylpolysaccharides and mixtures thereof such as those, for example, from the ®Atplus range from Uniqema, preferably Atplus 435,
e2) alkylpolyglycosides in the form of the APG® grades from Henkel, an example being ®Plantaren APG 225 (fatty alcohol C₈-C₁₀ glucoside),
e3) sorbitan esters in the form of the Span® or Tween® grades from Uniqema,
e4) cyclodextrin esters or ethers from Wacker,
e5) surface-active cellulose derivatives and algin, pectin, and guar derivatives such as the Tylose® grades from Clariant, the Manutex® grades from Kelco, and guar derivatives from Cesalpina,
e6) alkylpolyglycoside-alkylpolysaccharide mixtures based on C₈-C₁₀ fatty alcohol, such as ®Glucopon 225 DK and ®Glucopon 215 CSUP (Cognis).

Preferred components (e) are the alkylpolyglycosides-alkylpolysaccharide mixtures such as Atplus 435.

The formulations of the invention comprise as component (f) inorganic salts from the group of ammonium salts, examples being ammonium sulfate, ammonium chloride, ammonium bromide, preferably ammonium sulfate.

The use of alkylpolyglycosides as surfactants in crop protectant compositions is known in principle (see, for example, EP-A-0511611=U.S. Pat. No. 5,258,358). It is also mentioned therein that ammonium sulfate can be added as a frost protectant. Specific examples are absent, however, in relation to this. Moreover, it has not been recognized to date that with the combination of the surfactants (e) and the salts (f) it is possible to produce formulations having particularly high concentrations of active ingredients (a) and (b) and surfactants (d) and being also of very high activity.

The formulations of the invention may where appropriate comprise other anionic, nonionic, cationic and/or zwitterionic surfactants as component (g). Examples of such surfactants have been mentioned above in connection with component (d).

The formulations of the invention comprise, as component (h), customary formulation assistants, examples being inert materials, such as stickers, wetters, dispersants, emulsifiers, penetrants, preservatives, and frost protectants, fillers, carriers, and colorants, evaporation inhibitors, and pH modifiers (buffers, acids, and bases) or viscosity modifiers (e.g., thickeners) or defoamers.

In the case of the aqueous formulations it is often advantageous to add defoamers. Suitable defoamers include all customary defoamers, preferably silicone-based defoamers, such as silicone oils, for example.

Preferred defoamers are those from the group of linear polydimethylsiloxanes having an average dynamic viscosity, measured at 25° C., in the range from 1000 to 8000 mPas (mPas=millipascal-second), preferably 1200 to 6000 mPas, and containing silica. Silica comprehends forms/modifications such as polysilicic acids, meta-silicic acid, ortho-silicic acid, silica gel, silicic acid gels, kieselguhr, precipitated SiO₂, etc.

Defoamers from the group of linear polydimethylsiloxanes contain as their chemical backbone a compound of the formula HO—[Si(CH₃)₂-O—]ₙ—H, in which the end groups are modified, by etherification for example, or, in general, are attached to the groups —Si(CH₃)₃.

The amount of silica can be modified within a wide range and is generally situated in the range from 0.1 to 10 percent by weight, preferably 0.2 to 5 percent by weight, in particular 0.2% to 2% by weight, of silica, based on the weight of polydimethylsiloxane. Examples of defoamers of this kind are ® Rhodorsil Antifoam 416 (Rhodia) and ®Rhodorsil Antifoam 481 (Rhodia).

®Rhodorsil Antifoam 416 is a medium-viscosity silicone oil having a dynamic viscosity at 25° C. of about 1500 mPas and containing surfactant and silica. Because of the surfactant content the density is reduced as compared with the unadditized silicone oil, and amounts to about 0.995 g/cm³.

®Rhodorsil Antifoam 481 is a medium-viscosity silicone oil having a dynamic viscosity at 25° C. of about 4500 mPas and containing silica. The density amounts to about 1.045 g/cm³.

Further defoamers from the silicone group are Rhodorsil 1824, Antimussol 4459-2 (Clariant), Defoamer V 4459 (Clariant), SE Visk and AS EM SE 39 (Wacker). The silicone oils can also be used in the form of emulsions.

The assistants needed to prepare the formulations indicated above, such as surfactants in particular, are known in principle and are described, for example, in the following: McCutcheon's “Detergents and Emulsifiers Annual”, MC Publ. Corp., Ridgewood N.J.; Sisley and Wood “Encyclopedia of Surface Active Agents”, Chem. Publ. Co. Inc., N.Y. 1964; Schönfeldt, “Grenzflächenaktive Äthylenoxidaddukte”, Wiss. Verlagsgesellschaft, Stuttgart 1976; Winnacker-Küchler, “Chemische Technologie”, Volume 7, C. Hanser-Verlag, Munich, 4th Edition 1986, and references cited in each of these.

With the aid of mixtures of components it is accordingly possible to prepare preferably concentrated liquid aqueous preparations of saltlike active crop protectant ingredients, such as glufosinate-ammonium, comprising
(a) 1% to 50%, preferably 2% to 40%, and in particular 5% to 30% by weight of water-soluble active crop protectant ingredients (type (a) ingredients),
(b) 0 to 40%, preferably 0 to 20%, and in particular 0 to 10% by weight of water-insoluble active crop protectant ingredients (type (b) ingredients),
(c) 0 to 50%, preferably 0 to 30%, and in particular 0 to 20% by weight of organic solvents, preferably polar organic solvents,
(d) 1 % to 80%, preferably 5% to 70%, and in particular 6% to 60% by weight of nonionic, anionic, cationic and/or zwitterionic surfactants,
(e) 0.1% to 20%, preferably 0.5% to 15%, in particular 1% to 10% by weight of nonionic surfactants from the group of the alkylpolyglycosides,
(f) 0.1% to 25%, preferably 0.5% to 20%, and in particular 1% to 12% by weight of inorganic salts from the group of ammonium salts,
(g) 0 to 20%, preferably 0 to 15%, by weight of other nonionic, anionic, cationic and/or zwitterionic surfactants,
(h) 0 to 30%, preferably 0 to 20%, more preferably 0 to 15% by weight of customary formulation assistants, and
(i) 0.1% to 90% by weight, preferably 5% to 70% of water, more preferably 10% to 50% of water.

The weight ratio of the nonionic surfactants (e) to the inorganic salts specified under (f) is generally in the range from 20:1 to 1:20, preferably 10:1 to 1:15, in particular 5:1 to 1:10, and especially 1:1 to 1:2.

The weight ratio of the herbicides (a) to the anionic surfactants specified under (d) is generally in the range from 5:1 to 1:10, preferably 5:1 to 1:10, in particular 2:1 to 1:6.

The weight ratio of herbicides (a) to the nonionic surfactants (e) is generally in the range from 20:1 to 1:1, preferably 10:1 to 2:1, especially 8:1 to 3:1.

Preference is further given to aqueous solutions, preferably single-phase solutions, comprising
(a) 1% to 50%, preferably 2% to 40%, and in particular 5% to 30% by weight of water-soluble active crop protectant ingredients (type (a) ingredients),
(c) 0% to 40%, preferably 0 to 30%, and in particular 0 to 20% by weight of organic solvents, preferably polar organic solvents,
(d) 1% to 80%, preferably 5% to 70%, and in particular 6% to 60% by weight of nonionic, anionic, cationic and/or zwitterionic surfactants,
(e) 0.1% to 20%, preferably 0.5% to 15%, in particular 1% to 10% by weight of nonionic surfactants from the group of the alkylpolyglycosides,
(f) 0.1% to 25%, preferably 0.5% to 20%, and in particular 1% to 12% by weight of inorganic salts from the group of ammonium salts,
(g) 0 to 15%, preferably 0 to 10%, by weight of other nonionic, anionic, cationic and/or zwifterionic surfactants,
(h) 0 to 30%, preferably 0 to 20%, more preferably 0 to 15% by weight of customary formulation assistants, and
(i) 0.1% to 90% by weight, preferably 5% to 70% of water, more preferably 10% to 50% of water.

The solvents which can be admixed for preparing the aqueous single-phase solution are in particular organic solvents of unlimited or substantial miscibility with water, such as N-methylpyrrolidone (NMP), dimethylformamide (DMF), dimethylacetamide (DMA) or Dowanol® PM (propylene glycol monomethyl ether), for example.

Examples of customary formulation assistants (h) are the stated inert materials, frost protectants, evaporation inhibitors, preservatives, colorants, etc.; preferred formulation assistants (h) are
frost protectants and evaporation inhibitors such as glycerol or ethylene glycol, in an amount from 2% to 10% by weight, for example, and
preservatives, e.g., Mergal K9N® (Riedel) or Cobate C®,
defoamers.

The liquid formulations of the invention can be prepared by processes which are customary in principle, i.e., by mixing the components with stirring or shaking or by means of static mixing techniques. The liquid formulations obtained are stable with good storage properties.

The combination of inorganic salts from the group of ammonium salts such as ammonium sulfate and of the nonionic surfactant from the group of the alkylpolyglycosides such as Atplus 435 (Uniqema) (=alkylpolyglycoside mixture) allow higher concentrations of active ingredient and/or anionic surfactant, the activity obtained being similar or in some cases better than that of the conventional formulations—the comparison is with the activity of less concentrated formulations. This also implies a reduction in production, packaging, storage, and transit costs.

Consequently the formulations of the invention are especially suitable for use in crop protection—for example, where active herbicidal ingredients are included, for controlling unwanted plant growth both on uncultivated land and in tolerant crops.

In the examples which follow, amounts are by weight, unless indicated otherwise. The examples of tables 1 and 2 relate to stable compositions of the invention. The section “Biological examples” summarizes results of biological trials.

TABLE 1
Formulations (inventive)

| | 1 ⁽¹⁾ | 2 | 3 | 4 | 5 | 6 | 7 | 8 | 9 | 10 | 11 |
|---|---|---|---|---|---|---|---|---|---|---|---|
| Glufosinate-ammonium (a.i.) | 25.00 | 25.00 | 25.00 | 25.00 | 25.00 | 25.00 | 25.00 | 25.00 | 25.00 | 25.00 | 25.00 |
| TEGO XP 5902 ⁽²⁾ | 35.00 | | | | | | | | | | |
| Empilan KA 5 ⁽²⁾ | | 35.00 | | | | | | | | | |
| C₁₂/C₁₄—O-(EO)₂—SO₃^{—}Na^{+ (2)} | | | 35.00 | 30.00 | 25.00 | 20.00 | 15.00 | 10.00 | | | |
| Sapogenat T 300 ⁽²⁾ | | | | | | | | | 35.00 | | |
| Berol 900 ⁽²⁾ | | | | | | | | | | 35.00 | |
| Geropon CF 812-I ⁽²⁾ | | | | | | | | | | | 35.00 |
| Atplus 435 ⁽³⁾ | 5.00 | 5.00 | 5.00 | 5.00 | 5.00 | 5.00 | 5.00 | 5.00 | 5.00 | 5.00 | 5.00 |
| Ammonium sulfate | 7.00 | 7.00 | 7.00 | 7.00 | 7.00 | 7.00 | 7.00 | 7.00 | 7.00 | 7.00 | 7.00 |
| Propylene glycol monomethyl ether | | | 3.00 | | 3.00 | | 3.00 | | | | |
| Propylene glycol | 3.00 | 3.00 | | 3.00 | | 3.00 | | 3.00 | 3.00 | 3.00 | 3.00 |
| Rhodorsil 481 ⁽⁴⁾ | 0.5 | 0.5 | 0.5 | 0.3 | 0.3 | 0.3 | 0.3 | 0.3 | 0.3 | 0.25 | 0.5 |
| Water (ad 100%) | ad 100 | ad 100 | ad 100 | ad 100 | ad 100 | ad 100 | ad 100 | ad 100 | ad 100 | ad 100 | ad 100 |

TABLE 2
Formulations (inventive)

| | 12 ⁽¹⁾ | 13 | 14 | 15 | 16 | 17 | 18 | 19 |
|---|---|---|---|---|---|---|---|---|
| Glufosinate-ammonium (a.i.) | 25.00 | 25.00 | 25.00 | 25.00 | 25.00 | 25.00 | 25.00 | 25.00 |
| C₁₂/C₁₄—O-(EO)₂—SO₃^{—}Na^{+ (2)} | 35.00 | 35.00 | 35.00 | | | 35.00 | | |
| Glucopon 225 DK ⁽³⁾ | | | | 35.00 | | | 35.00 | |
| Glucopon 215 CSUP ⁽³⁾ | | | | | 35.00 | | | 35.00 |
| Atplus 435 ⁽³⁾ | 5.00 | 5.00 | 5.00 | 5.00 | 5.00 | 5.00 | 5.00 | 5.00 |
| Ammonium sulfate | 7.00 | 7.00 | 7.00 | 7.00 | 7.00 | 7.00 | 7.00 | 7.00 |
| Propylene glycol monomethyl ether | 3.00 | | 3.00 | | | | | |
| Propylene glycol | | 2.75 | | 2.50 | 2.50 | 2.50 | 2.50 | 2.50 |
| Rhodorsil 481 ⁽⁴⁾ | 0.25 | | | | | | | |
| Rhodorsil 416 ⁽⁵⁾ | | 0.25 | | | | | | |
| Antimussol 4459-2 ⁽⁶⁾ | | | 0.50 | 0.50 | 0.50 | | | |
| Rhodorsil 454 ⁽⁷⁾ | | | | | | 0.50 | 0.50 | 0.50 |
| Water (ad 100%) | ad 100 | ad 100 | ad 100 | ad 100 | ad 100 | ad 100 | ad 100 | ad 100 |

Abbreviations in tables 1 and 2:
⁽¹⁾ in the columns the compositions of the formulations 1 to 11 (in table 1) and 14 to 19 (in table 2) are specified, the respective line containing the amount of the component identified in the first column, as a weight percentage;
(a.i.) amount based on active ingredient
⁽²⁾ C₁₂/C₁₄—O-(EO)₂—SO₃^{—}Na⁺ = C₁₂/C₁₄ fatty alcohol diethylene glycol ether sulfate (used as ®Genapol LRO, Clariant),
®TEGO XP 5902 = blend of trisiloxane and a sodium salt solution (Degussa)
®Empilan KAS = ethoxylated alcohol with 5 EO (Huntsman);
®Sapogenat T 300 = triisobutylphenol ethoxylate with 30 EO (Clariant),
®Berol 900 = alkylglyceride (castor ethoxylate) with 40 EO (Akzo-Nobel),
®Geropon-CF 812-I = sulfosuccinate amine salt (Rhodia)
⁽³⁾ ®Glucopon 225 DK = alkylpolyglycoside-alkylpolysaccharide mixture based on C₈-C₁₀ fatty alcohol (Cognis),
®Glucopon 215 CSUP = alkylpolyglycoside-alkylpolysaccharide mixture based on C₈-C₁₀ fatty alcohol (Cognis),
®Atplus 435 = alkylpolyglycoside-alkylpolysaccharide mixture (Uniqema)
⁽⁴⁾ ®Rhodorsil 481 = polydimethylsiloxane oil with silica gel (Rhodia)
⁽⁵⁾ ®Rhodorsil 416 = polydimethylsiloxane oil with silica gel and surfactant (Rhodia)
⁽⁶⁾ ®Antimussol 4459-2 = silicone-based defoamer emulsion (Clariant)
⁽⁷⁾ ®Rhodorsil 454 = defoamer based on polydimethylsiloxane oil without silica (Rhodia)

### BIOLOGICAL EXAMPLES

The formulations of tables 1 and 2 were diluted with water and applied at a water application rate of 200 l/ha to uncultivated land containing a spectrum of weed plants that had emerged under natural conditions. Evaluation after 4 weeks revealed that the green parts of the weed plants had died off and therefore that effective control of the weed plants had been achieved.

1. A liquid aqueous crop protectant composition comprising
(a) one or more water-soluble active crop protectant ingredients (type (a) active ingredients),
(b) if desired, one or more water-insoluble active crop protectant ingredients (type (b) active ingredients),
(c) if desired, organic solvents,
(d) nonionic, cationic, anionic and/or zwitterionic surfactants,
(e) nonionic surfactants from the group of the alkylpolyglycosides,
(f) inorganic salts from the group of ammonium salts,
(g) if desired, other nonionic, anionic, cationic and/or zwitterionic surfactants,
(h) if desired, other customary formulation assistants, and
(i) water.

2. The crop protectant composition as claimed in claim 1, comprising
(a) 1% to 50% by weight of water-soluble active crop protectant ingredients (type (a) active ingredients),
(b) 0 to 40% by weight of water-insoluble active crop protectant ingredients (type (b) active ingredients),
(c) 0% to 50% by weight of organic solvents,
(d) 1% to 80% by weight of nonionic, anionic, cationic and/or zwitterionic surfactants,
(e) 0.1% to 20% by weight of nonionic surfactants from the group of the alkylpolyglycosides,
(f) 0.1% to 25% by weight of inorganic salts from the group of ammonium salts,
(g) 0 to 20% by weight of other nonionic, anionic, cationic and/or zwitterionic surfactants,
(h) 0 to 30% by weight of customary formulation assistants, and
(i) 0.1% to 90% by weight of water.

3. The crop protectant composition as claimed in claim 1, comprising
(a) 1% to 50% by weight of water-soluble active crop protectant ingredients (type (a) active ingredients),
(c) 0 to 40% by weight of organic solvents,
(d) 1% to 80% by weight of nonionic, anionic, cationic and/or zwitterionic surfactants,
(e) 0.1% to 20% by weight of nonionic surfactants from the group of the alkylpolyglycosides,
(f) 0.1% to 25% by weight of inorganic salts from the group of ammonium salts,
(g) 0 to 15% by weight of other nonionic, anionic, cationic and/or zwitterionic surfactants,
(h) 0 to 30% by weight of customary formulation assistants, and
(i) 0.1% to 90% by weight of water.

4. The crop protectant composition as claimed in claim 1, wherein the active ingredient of type (a) is glufosinate-ammonium.

5. The crop protectant composition as claimed in claim 1, wherein the weight ratio of the nonionic surfactants (e) to the inorganic salts specified under (f) is in the range from 20:1 to 1:20.

6. The crop protectant composition as claimed in claim 1, wherein the weight ratio of the herbicides (a) to the anionic surfactants specified under (d) is in the range from 5:1 to 1:10.

7. The crop protectant composition as claimed in claim 1, wherein the weight ratio of the herbicides (a) to the nonionic surfactants (e) is in the range from 20:1to1:1.

8. A process for producing a crop protectant composition as defined in claim 1, which comprises mixing components (a) to (h) and, if desired, further components present in the formulation with water (component (i)).

9. A method of controlling unwanted plant growth, which comprises applying an effective amount of a crop protectant composition as claimed in claim 1, comprising one or more active herbicidal ingredients, to the plants, parts of plants, or the area under cultivation.

10. A method of controlling a pest which comprises applying an effective amount of a crop protectant composition as claimed in claim 1 and comprising active ingredients effective against such pests, to the cultivation area or the non-crop area where the pest occurs.
